(19) United States
(12) Patent Application Publication
(10) Pub. No.: US 2003/0235292 A1
(43) Pub. Date: Dec. 25, 2003

(54) Dual tone multi-frequency decoder combines software and hardware and method of operating the same

(76) Inventor: George Cheng, Shanghai (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,641

(22) Filed: Aug. 1, 2002

(30) Foreign Application Priority Data
Jun. 24, 2002 (TW) 91113727

(51) Int. Cl. H04M 1/00; H04M 9/00

(52) U.S. Cl. 379/387.01

(57) ABSTRACT

The present invention provides a DTMF decoder that combines software and hardware and the method of operating the same. The DTMF decoder that combines software and hardware comprises an amplifier, an analog to digital convert, and a CPU or a digital logic circuit. The amplified DTMF signal is converted from analog to digital via the analog to digital converter according to the present invention. Since the digital DTMF signal converted from analog to digital integrally preserves the spectrum message of the DTMF signal, the digital DTMF signal can be further decoded by the CPU or the digital logic circuit. Therefore, the decoding error problem due to the software decoding method can be solved. In addition, when compared with the DTMF decoder with the hardware decoding method, the DTMF decoder that combines software with hardware of the present invention significantly reduces the cost, and even provides better performance and more flexibility in application when compared with the hardware decoding method.

### CROSS REFERENCE TO RELATED APPLICATIONS

This application claims the priority benefit of Taiwan application serial no. 91113727, filed on Jun. 24, 2002.

### BACKGROUND OF THE INVENTION

1. Field of Invention

The present invention generally relates to a dual tone multi-frequency decoder and the method of operating the same, and more particularly, related to a dual tone multi-frequency decoder that combines software and hardware and the method of operating the same.

2. Description of Related Art

The Dual Tone Multi-Frequency (acronym as DTMF) decoder is widely applied in the decoding of the DTMF signal in the caller ID and the short message service (acronym as SMS) of the telephone. The currently used DTMF decoder can be divided into the hardware decoding and the software decoding methods if it is divided by the decoding method. The DTMF decoder with the hardware decoding method has the advantage of better performance and better stability, however the circuit is rather complicated and the cost is rather higher. The DTMF decoder with the software decoding method has the advantage of simple circuit and low cost, however the performance and the stability are not so good.

The principle of the hardware decoding method for the DTMF decoder is using two simulated band pass filters to separate the high frequency signal and the low frequency signal in the DTMF signal at first, then the separated high frequency signal and the low frequency signal respectively pass through the comparator and the counter to calculate the frequency of the high frequency signal and the frequency of the low frequency signal, so that the DTMF signal decoding operation can be completed. FIG. 1 schematically shows a sketch map of the structure of a DTMF decoder 10 with the hardware decoding method. As shown in FIG. 1, the DTMF decoder 10 comprises an amplifier 102, a high frequency set band pass filter 104, a low frequency set band pass filter 106, a comparator 108, a comparator 110, a counter 112, and a counter 114. The DTMF decoder 10 is operated by the following steps: at first, the differentiating DTMF signal between TIP and RING is amplified as an amplified DTMF signal by using the amplifier 102. Then, a high frequency signal in the amplified DTMF signal is separated and the amplified high frequency DTMF signal is output by using the high frequency set band pass filter 104, and a low frequency signal in the amplified DTMF signal is separated and the amplified low frequency DTMF signal is output by using the low frequency set band pass filter 106. The amplified high frequency DTMF signal subsequently passes through the comparator 108 and the counter 112 to calculate a frequency of the amplified high frequency DTMF signal, and the amplified low frequency DTMF signal subsequently passes through the comparator 110 and the counter 114 to calculate a frequency of the amplified low frequency DTMF signal, so that the DTMF signal decoding operation can be completed. Finally, the decoded DTMF signal is sent to the central processing unit (acronym as CPU) 116 for further processing.

Although the performance of the DTMF decoder with the hardware decoding method mentioned above is rather reliable, it has the disadvantage of complicated circuit and high cost. In order to reduce the circuit cost, a DTMF decoder with the software decoding method has appeared in the market in recent years. FIG. 2 schematically shows a sketch map of the structure of a DTMF decoder 20 with the software decoding method. As shown in FIG. 2, the DTMF decoder 20 comprises an amplifier 202 and a CPU 204. The DTMF decoder 20 is characterized in that the amplified DTMF signal is sent to the CPU 204 after the DTMF signal TIP and the DTMF signal RING are amplified and reshaped by the amplifier 202. The CPU 204 subsequently processes the amplified DTMF signal by using a digital filtering method to complete the DTMF signal decoding operation. In such software decoding method, since the spectrum read by the CPU 204 is a square wave of the amplified DTMF signal that had been amplified and reshaped, there is a difference between the spectrum of the amplified DTMF signal and the spectrum of the original DTMF signal (i.e. the differentiating DTMF signal between TIP and RING exists). Therefore, when the difference of the amplitude of the high frequency signal and the amplitude of the low frequency signal in the amplified DTMF signal is rather big (e.g. over ±6 dB), the DTMF decoder with such a software decoding method will generate decoding errors.

### SUMMARY OF THE INVENTION

Therefore, the present invention provides a DTMF decoder that combines software and hardware and the method of operating the same. The amplified DTMF signal is converted from analog to digital via the analog to digital converter (A/D converter) according to the present invention. Since the digital DTMF signal converted from analog to digital integrally preserves the spectrum message of the DTMF signal, the digital DTMF signal can be further decoded by the CPU or the digital logic circuit. Therefore, the decoding error problem due to the software decoding method can be solved.

In order to achieve the objective mentioned above and others, the present invention provides a DTMF decoder that combines software and hardware. The DTMF decoder that combines software and hardware comprises an amplifier, and analog to digital converter, and a CPU. The amplifier used to amplify and reshape the DTMF signal outputs the amplified DTMF signal. The analog to digital converter coupled to the amplifier converts the amplified DTMF signal from analog to digital and outputs the digital DTMF signal. The CPU coupled to the analog to digital converter performs the digital filtering on the digital DTMF signal to complete the decoding operation.

In a preferred embodiment of the present invention, the amplifier comprises a non-invert terminal, an invert terminal, and an output terminal. The non-invert terminal and the invert terminal respectively couple to the TIP and RING terminal of the telephone line, and the output terminal outputs the amplified DTMF signal.

The present invention also provides a DTMF decoder that combines software and hardware. The DTMF decoder that combines software and hardware comprises an amplifier, and analog to digital converter, and a digital logic operation circuit. The amplifier used to amplify and reshape the DTMF signal outputs the amplified DTMF signal. The analog to digital converter coupled to the amplifier converts the amplified DTMF signal from analog to digital and outputs the digital DTMF signal. The digital logic operation circuit coupled to the analog to digital converter performs the digital filtering on the digital DTMF signal to complete the decoding operation.

The present invention further provides an operating method for the DTMF decoder that combines software and hardware. In the operating method, at first the DTMF signal is amplified and reshaped and the amplified DTMF signal is output. The amplified DTMF signal is subsequently converted from analog to digital, and the digital DTMF signal is output. Afterwards, the digital filtering is performed on the digital DTMF signal to complete the decoding operation.

In a preferred embodiment of the present invention, the DTMF signal is amplified and reshaped by using the amplifier.

In a preferred embodiment of the present invention, the amplified DTMF signal is converted from analog to digital by using the analog to digital converter.

In a preferred embodiment of the present invention, the digital filtering is performed on the digital DTMF signal to complete the decoding operation by using the CPU or the digital logic operation circuit.

In summary, the amplified DTMF signal is converted from analog to digital via the analog to digital converter according to the present invention. Since the digital DTMF signal converted from analog to digital integrally preserves the spectrum message of the DTMF signal, the digital DTMF signal can be further decoded by the CPU or the digital logic circuit. Therefore, the decoding error problem due to the software decoding method can be solved. In addition, the spectrum message of the DTMF signal collected does not need the high precision analog to digital converter (that is the 4 bits to 8 bits analog to digital converter is good enough). In the development of the DTMF decoder integrated circuit, the cost of the 4 bits to 8 bits analog to digital converter is much less than the two sets of the band pass filters and other circuits in the DTMF decoder with the hardware decoding method. Therefore, when compared with the DTMF decoder with the hardware decoding method, the DTMF decoder that combines with software and hardware of the present invention significantly reduces the cost, and even provides better performance and more flexibility in the application when compared with the hardware decoding method.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a sketch map of the structure of the DTMF decoder with the hardware decoding method;

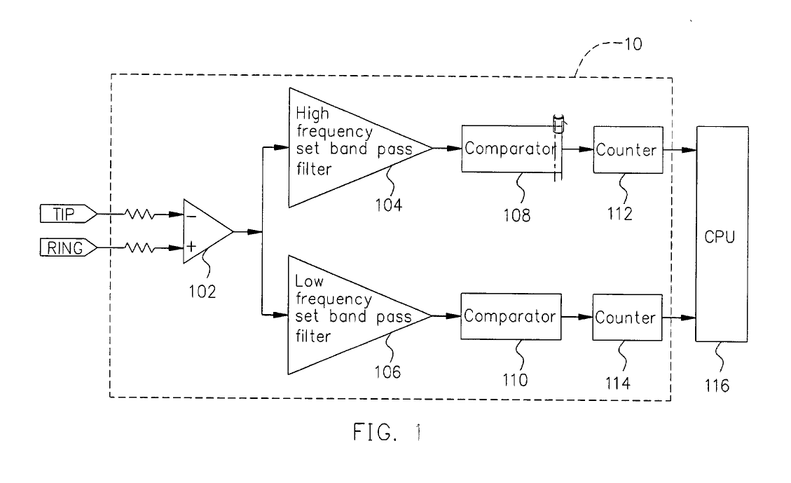

FIG. 2 s schematically shows a sketch map of the structure of the DTMF decoder with the software decoding method; and

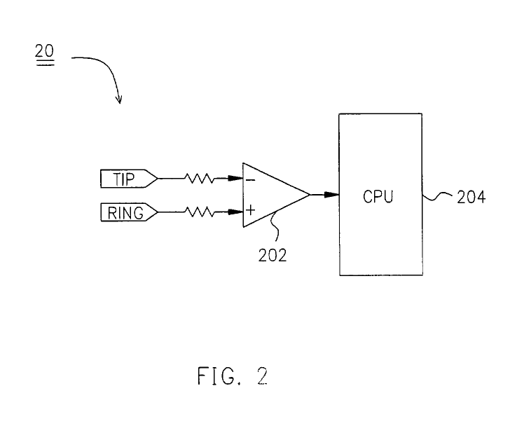

FIG. 3 schematically shows a sketch map of the structure of the DTMF decoder that combines software and hardware of a preferred embodiment according to the present invention.

### DETAILED DESCRIPTION

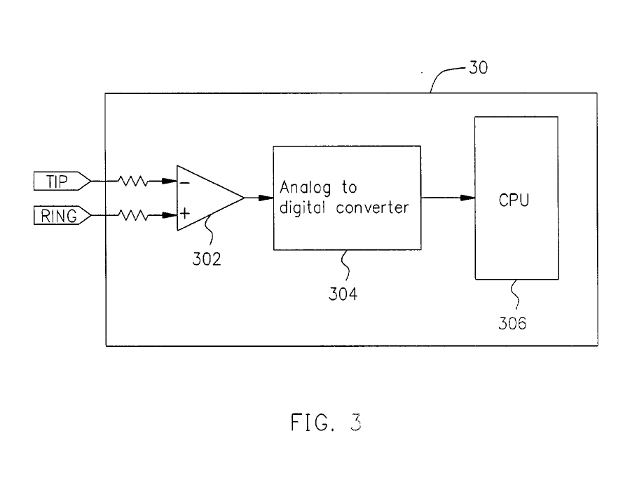

FIG. 3 schematically shows a sketch map of the structure of the DTMF decoder 30 that combines software and hardware of a preferred embodiment according to the present invention. The DTMF decoder 30 comprises an amplifier 302, an analog to digital converter 304, and a CPU 306. The function of each component of the DTMF decoder 30 is described in detail hereinafter.

The amplifier 302 comprises a non-invert terminal, an invert terminal, and an output terminal. The non-invert terminal and the invert terminal receive a differentiating DTMF signal between TIP and RING. The amplifier 302 amplifies and reshapes the received DTMF signal and outputs the amplified DTMF signal.

The analog to digital converter 304 coupled to the amplifier 302 converts the amplified DTMF signal from analog to digital and outputs the digital DTMF signal. The amplified DTMF signal is converted from analog to digital via the analog to digital converter 304. The digital DTMF signal converted from analog to digital integrally preserves the spectrum message of the DTMF signal when it is compared with the one obtained by using the DTMF decoder with the software decoding method. In addition, the spectrum message of the DTMF signal collected does not need the high precision analog to digital converter. In other words, the analog to digital converter only needs a 4 bits to 8 bits analog to digital converter. In the development of the DTMF decoder integrated circuit, the cost of the 4 bits to 8 bits analog to digital converter is much less than the two sets of the band pass filters and other circuits in the DTMF decoder with the hardware decoding method. Therefore, when compared with the DTMF decoder with the hardware decoding method, the DTMF decoder 30 of the present invention significantly reduces the cost and provides better performance than the DTMF decoder with the hardware decoding method.

The CPU 306 coupled to the analog to digital converter 304 performs the digital filtering on the digital DTMF signal to complete the decoding operation. The central frequency and the bandwidth of the digital filter can be flexibly adjusted by modifying the software setting. Moreover, the CPU 306 may be replaced with a digital logic operation circuit.

The operating method of the DTMF decoder 30 is described in detail hereinafter with accompanying FIG. 3. In the operating method, at first the amplifier 302 amplifies and reshapes the received DTMF signal and outputs the amplified DTMF signal. The analog to digital converter 304 subsequently converts the amplified DTMF signal from analog to digital and outputs the digital DTMF signal. Afterwards, the CPU 306 (or the digital logic operation circuit) performs the digital filtering on the digital DTMF signal to complete the DTMF signal decoding operation.

In summary, the amplified DTMF signal is converted from analog to digital via the analog to digital converter according to the present invention. Since the digital DTMF signal converted from analog to digital integrally preserves the spectrum message of the DTMF signal, the digital DTMF signal can be further decoded by the CPU or the digital logic circuit. Therefore, the decoding error problem due to the software decoding method can be solved. In addition, the spectrum message of the DTMF signal collected does not need the high precision analog to digital converter (that is the 4 bits to 8 bits analog to digital converter is good enough). In the development of the DTMF decoder integrated circuit, the cost of the 4 bits to 8 bits analog to digital converter is much less than the two sets of the band pass filters and other circuits in the DTMF decoder with the hardware decoding method. Therefore, when compared with the DTMF decoder with the hardware decoding method, the DTMF decoder that combines with software and hardware of the present invention significantly reduces the cost, and even provides better performance and more flexibility in the application when compared with the hardware decoding method. For example, the central frequency and the bandwidth of the digital filter can be flexibly adjusted by modifying the software setting.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A DTMF decoder that combines software and hardware, comprising:
an amplifier, used to amplify and reshape a DTMF signal and output an amplified DTMF signal;
an analog to digital converter, coupled to the amplifier, used to convert the amplified DTMF signal from analog to digital and output a digital DTMF signal; and
a CPU, coupled to the analog to digital converter, used to perform a digital filtering on the digital DTMF signal to complete a decoding operation.

2. The DTMF decoder that combines software and hardware of claim 1, wherein the amplifier comprises a non-invert terminal, an invert terminal, and an output terminal.

3. The DTMF decoder that combines software and hardware of claim 2, wherein the non-invert terminal couples to a first terminal of a telephone line, the invert terminal couples to a second terminal of the telephone line, and the output terminal outputs the amplified DTMF signal.

4. A DTMF decoder that combines software and hardware, comprising:
an amplifier, used to amplify and reshape a DTMF signal and output an amplified DTMF signal;
an analog to digital converter, coupled to the amplifier, used to convert the amplified DTMF signal from analog to digital and output a digital DTMF signal; and
a digital logic operation circuit, coupled to the analog to digital converter, used to perform a digital filtering on the digital DTMF signal.

5. The DTMF decoder that combines software and hardware of claim 4, wherein the amplifier comprises a non-invert terminal, an invert terminal, and an output terminal.

6. The DTMF decoder that combines software and hardware of claim 5, wherein the non-invert terminal couples to a first terminal of a telephone line, the invert terminal couples to a second terminal of the telephone line, and the output terminal outputs the amplified DTMF signal.

7. An operating method of a DTMF decoder that combines software and hardware, comprising:
amplifying and reshaping a DTMF signal to output an amplified DTMF signal;
converting the amplified DTMF signal from analog to digital to output a digital DTMF signal; and
performing a digital filter on the digital DTMF signal to complete a decoding operation.

8. The operating method of a DTMF decoder that combines software and hardware of claim 7, wherein the DTMF signal is amplified and reshaped by an amplifier.

9. The operating method of a DTMF decoder that combines software and hardware of claim 8, wherein the amplifier comprises an non-invert terminal, an invert terminal, and an output terminal.

10. The operating method of a DTMF decoder that combines software and hardware of claim 9, wherein the non-invert terminal couples to a first terminal of a telephone line, the invert terminal couples to a second terminal of the telephone line, and the output terminal outputs the amplified DTMF signal.

11. The operating method of a DTMF decoder that combines software and hardware of claim 7, wherein the amplified DTMF signal is converted from analog to digital by an analog to digital converter.

12. The operating method of a DTMF decoder that combines software and hardware of claim 7, wherein a digital filtering is performed on the digital DTMF signal to complete a decoding operation by a CPU.

13. The operating method of a DTMF decoder that combines software and hardware of claim 7, wherein a digital filtering is performed on the digital DTMF signal to complete a decoding operation by a digital logic operation circuit.
